(19) United States
(12) Patent Application Publication
(10) Pub. No.: US 2013/0173380 A1
(43) Pub. Date: Jul. 4, 2013

(54) System and Method for Mobile Advertising Configuration

(71) Applicants: Homaira Akbari, Washington, DC (US); Uday Shankar, Herndon, VA (US)

(72) Inventors: Homaira Akbari, Washington, DC (US); Uday Shankar, Herndon, VA (US)

(21) Appl. No.: 13/343,197

(22) Filed: Jan. 4, 2012

(51) Int. Cl. G06Q 30/02

(52) U.S. Cl. 705/14.43

(57) ABSTRACT

A system and method for mobile advertising configuration. A mobile advertising platform provides a service to advertisers in generating and managing an advertising campaign. The mobile advertising platform receives an advertiser's input regarding the duration, geographies, targeted demographics, expected performance such as number of impressions, and pricing requirements of an advertising campaign. The mobile advertising platform selects mobile advertisement carriers controlled by one or more fleet operators for inclusion in said advertising campaign based on profiles for the mobile advertisement carriers. The mobile advertising platform provides proof-of-performance metrics and operational metrics to the advertisers to enable management and optimization of the advertising campaign in real-time. The mobile advertising platform provides dynamic pricing to the advertisers for their advertising campaign in real-time.

### BACKGROUND

1. Field of the Invention

The present invention relates generally to advertising and, more particularly, to a system and method for mobile advertising configuration.

2. Introduction

Advertising is an essential tool for business success. Advertising in today's environment can depend on various forms of advertising. Traditional advertising outlets include printed media (e.g., newspapers, magazines, direct mailings, etc.), television and radio. Newer forms of advertising outlets include electronic media such as web-based advertising, emails, and social media.

In general, any advertising mechanism that can place an advertisement before a desired audience can operate as an effective advertising outlet. This is true regardless of the particular form of media in which the advertisement is carried. One area of advertising that has seen recent growth is mobile advertising. In one example, mobile advertising can be used in displaying advertisements on a mobile advertisement carrier such as a vehicle. The audience of such an advertisement would include those individuals that were in proximity to the mobile advertisement carrier as it traversed a geographic area.

While such an advertising mechanism can leverage an often unused advertising outlet, the effectiveness of an advertising campaign built on such an advertising mechanism is often speculative. What is needed therefore is a mechanism for ensuring greater predictability in mobile advertising through proper selection and configuration of mobile advertising campaigns.

### SUMMARY

A system and/or method for mobile advertising configuration, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a mobile out-of-home advertising system.

FIG. 2 illustrates an embodiment of a mobile tracking service provider that enables communication with a mobile terminal on a mobile advertisement carrier.

FIG. 3 illustrates an example calculation of an advertising effectiveness based on location updates generated by a mobile tracking service provider.

FIG. 4 illustrates an example of an analysis of the hours of movement of a mobile advertisement carrier against audience impressions.

FIG. 5 illustrates a flowchart of a process of configuring a mobile advertising campaign.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Advertising effectiveness is measured primarily by the relevant audience reached. In justifying the cost of an advertising campaign, advertisers require accurate, industry-accepted measurement of the audience of the advertising in the targeted geographic region of interest. Without accurate measurements of the advertising effectiveness, the advertiser's willingness to pay for the continued deployment of the advertising campaign will surely decline.

With mobile advertising, determination of the effectiveness of the advertising campaign is dependent on the accurate identification of the location and activity of the mobile advertisement carrier. Here, it should be noted that the mobile advertisement carrier can represent any mobile platform for an advertisement. In the description below, the principles of the present invention are described in the context of a trailer having an advertisement displayed thereon. The principles of the present invention are not so limited, however. As would be appreciated, the principles of the present invention can be applied to any advertising platform whose location can be tracked. Thus, in other examples, the mobile advertisement carrier can represent a car, truck, bus, rail car, shipping container, or any other platform that can host an advertisement and can be tracked.

In the present invention, it is recognized that configuration of a mobile advertising campaign is often difficult because the projected advertising effectiveness of a particular mobile advertisement carrier is difficult to quantify. For example, consider a fleet of trailers that are being considered for use as mobile advertisement carriers. Beyond a general sense of a geographic area in which the individual trailers are projected to operate, the fleet of trailers may be difficult to distinguish from the perspective of advertising effectiveness. Unless, the relative advertising effectiveness of two individual trailers operating in the same geographic region can be modeled and quantified, the configuration of an advertising campaign based on one or both of those trailers would rely on a sense that the trailers are fungible advertising commodities having relatively indistinguishable advertising value. The significant risk of such an ad hoc advertising configuration process is that the resulting advertising campaign would include a waste of advertising assets.

This waste can be represented in one example by the use of a greater than needed number of trailers for a particular advertising campaign. In effect, a shotgun approach would be used in an attempt to hit a particularly defined advertising target. In another example, the waste can be represented by the failure to capitalize on high-performing advertising assets that can be shown to consistently generate a high number of audience metrics. Unless these high-performing advertising assets can be identified and leveraged, the operators of such trailers cannot obtain the maximum value for the inclusion of their mobile advertising assets in a mobile advertising campaign.

In this context, it is a feature of the present invention that greater clarity can be achieved in the configuration of a mobile advertising campaign through the profiling of mobile advertisement carriers. With these advertising profiles, greater clarity can be achieved in configuring a particular advertising campaign with mobile advertisement carriers selected from an available set of mobile advertisement carriers. In general, the profiling of the mobile advertisement carriers provides greater visibility into the value and efficacy of potential mobile advertisement carriers in fulfilling particular advertising goals. In effect, what is created is a marketplace of individually-defined mobile advertisement carrier assets as a replacement for a conventional marketplace of fungible advertising assets.

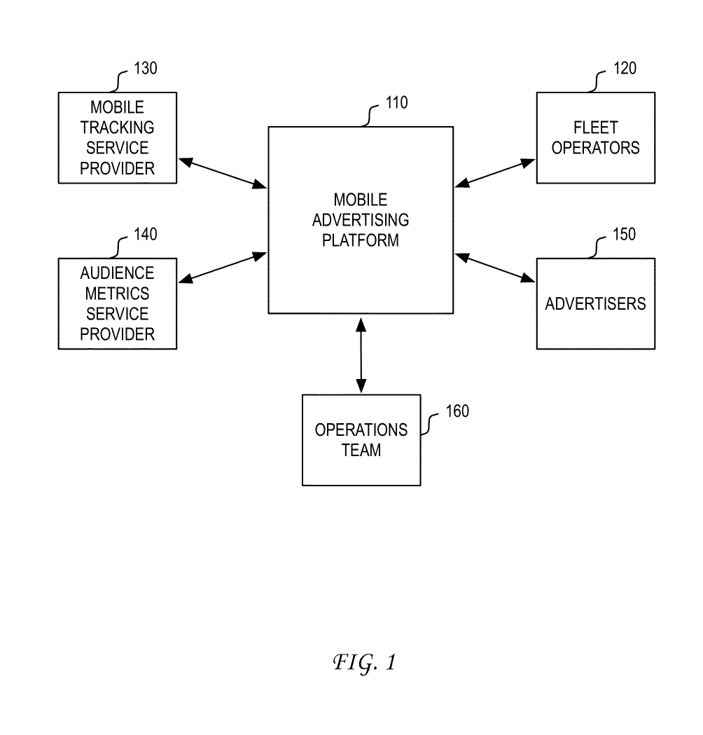

FIG. 1 illustrates an embodiment of a mobile advertising system in accordance with the present invention. As illustrated, the mobile advertising system includes a mobile advertising platform 110 that interfaces with fleet operators 120, mobile tracking service provider 130, audience metrics service provider 140, advertisers 150, and operations team 160. In general, mobile advertising platform 110 is designed to provide a service for advertisers 150 to generate and manage advertising campaigns. Here, it should be noted that advertisers 150 can represent any entity that is responsible for interfacing with mobile advertising platform 110 in configuring an advertising campaign on behalf of themselves or a third party. As such, advertisers 150 can represent a corporation desiring to launch an advertising campaign to promote the corporation's product or service, a media agency that is configuring an advertising campaign on behalf of a client, a middle man that communicates a third party's advertising intent to mobile advertising platform 110, etc.

in one example, mobile advertising platform 110 can receive input from advertiser 150 in the form of an advertising campaign duration, a geographic scope of the advertising campaign, an expected performance of the advertising campaign, pricing requirements for the advertising campaign, etc. Based on this input, operations team 160 can then configure the advertising campaign through the generation of an advertising requirements model based on the input from advertiser 150, and a selection of mobile advertisement carriers operated by fleet operators 120. Finally, mobile advertising platform 110 can generate results in the form of proof-of-performance metrics as well as operational metrics as may be required by advertiser 150. As will be described in greater detail below, the profiling of mobile advertisement carriers enables mobile advertising platform 110 to simplify the previously burdensome advertising configuration process where the advertiser 150 selects the mobile advertisement carriers on which the advertisement is to run, the number of instances of such advertisements, etc.

As illustrated, mobile advertising platform 110 interfaces with fleet operators 120. In one embodiment, fleet operators 120 interface with mobile advertising platform 110 via a web-based interface or a mobile hand-held device application.

In general, a plurality of fleet operators 120 can interface with mobile advertising platform 110 in managing a plurality of mobile advertisement carriers under their control. For example, a fleet operator can interface with mobile advertising platform 110 in providing information regarding a plurality of trailers that can be used by advertisers 150 in configuring a mobile advertising campaign. In various examples, fleet operators 120 can include car fleet operators (e.g., taxi operator), bus fleet operators (e.g., public transit authority, public school systems, etc.), rail car operators, etc. that can be used alone or in combination in a configured advertising campaign.

As part of the management of their fleet of mobile advertisement carriers, fleet operators 120 can provide mobile advertising platform 110 with information useful in the configuration of an advertising campaign. For example, fleet operators 120 can provide a Trailer ID, Trailer type (including dimensions and other specifics) as well as type, frequency and geography of operation. In addition to such basic fleet information, fleet operators 120 can also continually update mobile advertising platform 110 with scheduling information that would indicate when individual mobile advertisement carriers are available or unavailable (e.g., scheduled maintenance) for use in an advertising campaign. These updates would enable mobile advertising platform 110 to properly leverage and rapidly deploy all available mobile advertisement carriers cost-efficiently in advertising campaigns initiated by advertisers 150.

As will be described in greater detail below, access by fleet operators 120 to mobile advertising platform 110 would enable access to profile information that would indicate the advertising value of individual mobile advertisement carriers under the control of that fleet operator. Moreover, fleet operators 120 can access report information regarding past, current and future projections of advertising revenues being generated by their fleet of mobile advertisement carriers.

In the present invention, the profiling of mobile advertisement carriers is enabled through the tracking of both the location and activity of the mobile advertisement carriers. This tracking of the location and activity of the mobile advertisement carriers is performed by mobile tracking service provider 130.

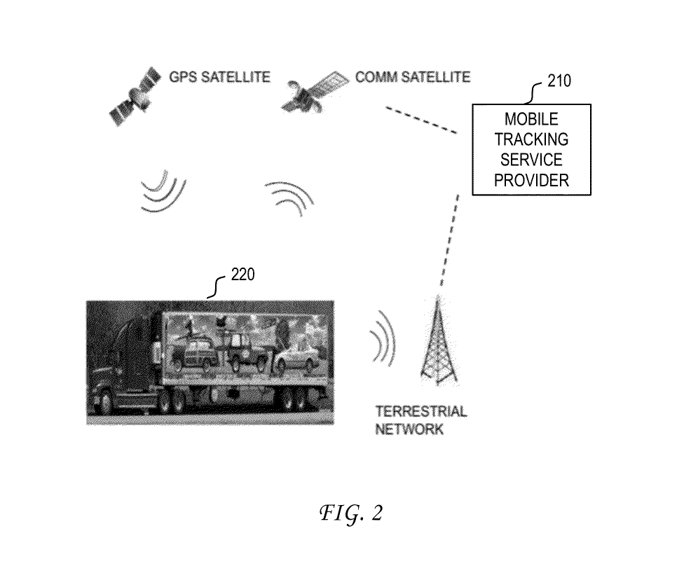

FIG. 2 illustrates an embodiment of a mobile advertisement carrier tracking system implemented by mobile tracking service provider 130. As illustrated, the mobile advertisement carrier tracking system includes a mobile tracking service provider 210 that can communicate with mobile advertisement carrier 220 such as a trailer. Communication between mobile tracking service provider 210 and mobile advertisement carrier 220 can be facilitated by a mobile terminal (not shown) that is affixed to mobile advertisement carrier 220. In various embodiments, the mobile terminal on mobile advertisement carrier 220 can be designed to communicate with mobile tracking service provider 210 via a communications satellite such as a geostationary (GEO) satellite, medium earth orbit (MEO) satellite, or low earth orbit (LEO) satellite, or via a terrestrial wireless network. As would be appreciated, the specific form of terrestrial wireless network would be implementation dependent as it can depend on the type of mobile advertisement carrier being tracked. In various examples, the terrestrial wireless network can be embodied as a cellular network, a Wi-Fi or other short range radio network, Real-Time Location System (RTLS), etc.

In facilitating the tracking of a location and activity of mobile advertisement carrier 220, the mobile terminal can be designed to receive signals from a Global Navigation Satellite System (GNSS) such as GPS or Galileo. As would be appreciated, the principles of the present invention are not dependent solely on tracking enabled by a GNSS. Rather, any mechanism whether satellite or terrestrial based or any other location determination technologies or methodologies that generates tracking information can be used. The particular choice of the tracking mechanism can be dependent on the type of mobile advertisement carrier being tracked, the frequency and rate of movement of the mobile advertisement carrier, etc.

In one embodiment, the mobile terminal affixed to the mobile advertisement carrier includes an adaptive motion sensor, which enables motion-activated location tracking In general, the adaptive motion sensor can be used to determine whether an asset is moving or not. In one example, when an asset begins to move, the adaptive motion sensor can detect the motion by measuring vibration signals. The adaptive motion sensor can then generate a signal that indicates that motion has started. This information can be reported to mobile tracking service provider 210 to facilitate a tracking of idle time and movements of the mobile advertisement carrier. An example of motion-activated location tracking is described in U.S. Pat. No. 7,486,174, entitled “System and Method for Adaptive Motion Sensing with Location Determination,” which is incorporated herein by reference in its entirety.

In the present invention, it is recognized that the historical analysis of the location and activity of a mobile advertisement carrier can be used to generate an advertising profile, which can be used to categorize the mobile advertisement carrier for advertising purposes and the relative advertising value of the mobile advertisement carrier. For example, consider a trailer that has a dedicated route within a particular geographic area. As the trailer is assigned to a dedicated route, the trailer would traverse a consistent path of roads, intersections, etc. through the particular geographic area at consistent times of day. This, of course, would be in contrast to another trailer that is used for non-designated routes within a geographic area.

Using the historical analysis of the location and activity of the trailer, mobile advertising platform 110 can generate an advertising profile for that trailer, which can enhance the initial profile submitted by the fleet operator. Significantly, the historical analysis of the location and activity of the trailer enables an advertising profile to be generated based on empirical analysis, not expectations or speculation. This profiling enables categorization of a trailer based on the expected advertising potential of that particular trailer.

This profile can be based, for example, on 90 days of tracking information that has been accumulated in mobile advertising platform 110 for that particular trailer. As would be appreciated, the specific amount of tracking data needed to generate a reasonable profile would vary as the amount of historical tracking data available can be used to generate confidence estimate indications for the projections of expected advertising potential.

It is a feature of the present invention that categorization of the expected advertising potential, and hence value, of individual mobile advertisement carriers can be used in configuring an advertising campaign. In one embodiment, the categorization of the relative advertising value of a mobile advertisement carrier is based on the combination of tracking information provided by mobile tracking service provider 130 and audience information provided by audience metrics service provider 140.

Here, it should be noted that the particular mechanism by which mobile tracking service provider 130 generates tracking data would be dependent on the type of mobile advertisement carrier and the tracking capabilities applicable thereto. In one example, the tracking data generated by mobile tracking service provider 130 can include latitude/longitude coordinates and a determined speed for each observation point. As would be appreciated, the interval (e.g., four minutes) between observation points can be implementation dependent.

In one embodiment, the interval between observation points can be designed to interoperate with processes of audience metrics service provider 140. It should be noted that where longer intervals between observation points are used, interpolation can be exploited using routing particular to that type of mobile advertisement carrier. For example, longer intervals between observation points can be compensated by determined routes that are particular to trailers.

In general, audience metrics service provider 140 can be designed to calculate a number of audience exposures to the mobile advertisement based on tracking data provided by mobile tracking service provider 130. In general, audience metrics service provider 140 can estimate how many people would have been exposed to the advertisement based on factors such as location, date, time, seasonality, illumination, persons per vehicle, and Department of Transportation growth rates.

In one example, audience metrics service provider 140 can provide the daily effective circulation (DEC), which can represent the average number of persons 18+ that have been potentially exposed to a mobile advertisement using factors that calibrate period of exposure, directional traffic and vehicle occupancy. In one implementation, the DEC impressions can be provided by audience metrics service provider 140 for each four-minute location update generated by mobile tracking service provider 130.

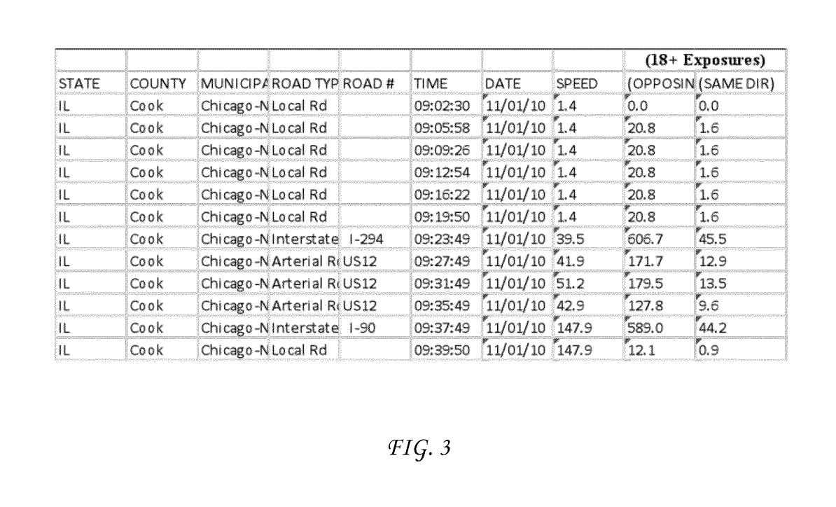

FIG. 3 illustrates an example of using DEC to determine the number of impressions for a trailer traversing a route defined by location updates that occur approximately every four minutes. In the example of FIG. 3, the exposures to an advertisement on a trailer is dependent on the speed of the trailer and includes exposures for traffic going in the same direction relative to the trailer as well as traffic going in the opposite direction relative to the trailer. The accumulation of the number of exposures for the span of location updates for the trailer can thereby indicate the advertising effectiveness for the trailer during that particular portion of the trailer's route. As noted, the accumulation of the number of exposures would span those location updates during which the trailer was not in an idle mode.

It should be noted that the principles of the present invention are not dependent on a particular audience metric such as DEC. Other metrics such as EYES ON can also be used. In general, the EYES ON measurement unit is EYES ON Impressions (EOIs), which measures the audience based on traffic, pedestrian viewership and an indicator on how likely a passer-by will notice the advertisement. Total EOIs can be reported for persons 18+ and can be reported against detailed demographics (e.g., age, sex, ethnicity, income, etc.). As would be appreciated, any other audience metric that can be correlated with tracking data can be used. In addition, data that supplements and/or replaces estimates of audience metrics such as DEC or EYES ON can also be used. For example, any additional data that reflects actual audience existence (e.g., mobile phone tracking) or audience responsiveness to the advertisement can be used in generating audience metrics. In one embodiment, audience metric information can be enhanced by a near real-time wireless and RF short range technologies which can measure number of people or cell phones or other indicators of people within certain geographic zones surrounding and encapsulating the mobile advertisement carrier. This information can then be further enhanced in partnership with service providers (mobile operators or other wireless service providers) who can provide the audience demographics and other characteristics or purchasing preferences.

Regardless of the particular audience metric used, the application of audience metric information from audience metrics service provider 140 to tracking data from mobile tracking service provider 130 enables mobile advertising platform 110 to generate historical profiles of the advertising performance of individual mobile advertisement carriers.

In the present invention, these historical profiles are also correlated across defined geographies. In one embodiment, designated market areas (DMAs) are defined by counties, wherein a county belongs to only one DMA. For the United States, 210 DMAs can be defined. In one embodiment, the geographic definitions of the DMAs can be enhanced with zip code and demographic data that includes population makeup, income ranges, etc.

In the example of trailer fleets, trailers can be organized into the following classifications: dedicated within DMA, non-dedicated within DMA, dedicated regional with 1-3 principal DMAs, and long haul with several principal DMAs. These classifications can be used to assist in the proper assignment of trailers to an advertising campaign to thereby generate a desired number of impressions in one or more geographies based on a fleet's movement.

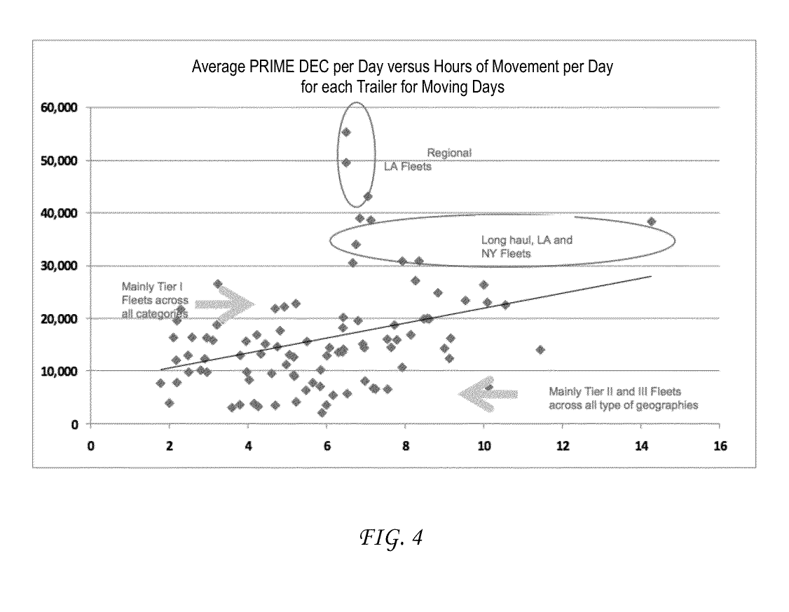

FIG. 4 illustrates an example of an analysis of the hours of movement of trailers against DEC during the prime hours of 6 AM and 6 PM. As illustrated, many of the trailers show a roughly proportional prime DEC performance relative to the number of hours of movement such that an increase in the number of hours of movement produces a proportional increase in the prime DEC performance. Not all trailer performance can be modeled by such a standard measure, however. In particular, certain long haul trailers produced greater than average prime DEC performance when analyzed over particular DMAs, while certain regional trailers produced exceptional average prime DEC performance with less than average hours of movement.

What this example performance analysis indicates is that not all trailers can be categorized in the same way. In fact, many trailers can be differentiated in their expected advertising potential. This differentiation in a trailer's expected advertising potential, i.e., mobile advertisement carrier's relative advertising value, can be leveraged in the matching of trailers to a given advertising campaign.

In the present invention, the dynamic categorization and valuation of trailers can be based on various criteria such as hours of service, times of services, percent time spent in different geographies traversed, size of trailer, miles traversed, etc. This results because of the accuracy of the location and activity data provided by the mobile tracking service provider. The end result is a categorization that provides an indication of the intrinsic relative advertising value for each trailer.

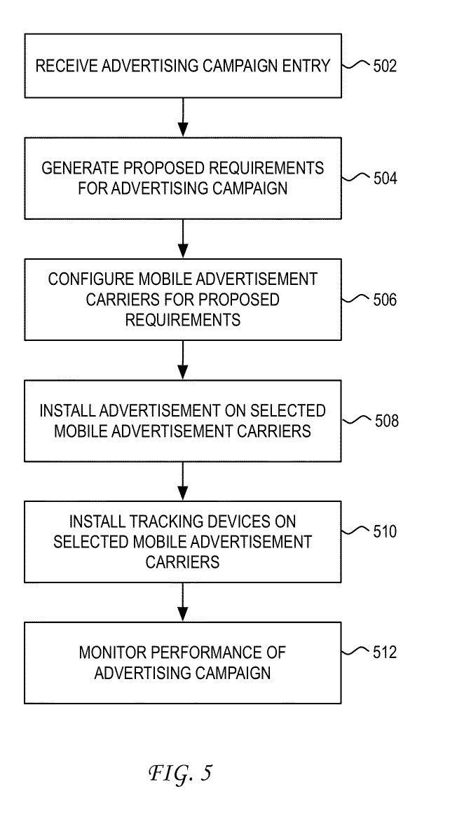

With the framework outlined above, an efficient mechanism for configuring a mobile advertising campaign is now provided with reference to the flowchart of FIG. 5. As illustrated, the process begins at step 502 where the requirements of an advertising campaign are received from an advertiser. In one embodiment, the advertiser provides the requirements of an advertising campaign through a web-based interface.

In one example, the advertiser can provide various types of information such as the name of the campaign, the start date of the campaign, the end date of the campaign, the duration of the campaign, one or more DMAs, details of the advertisement (e.g., size, content, etc.), the expected performance (e.g., average DEC per day for each target DMA), the desired target hours of operations, pricing requirements, etc. As would be appreciated, any information that can be used to define the goals of the advertising campaign can be received at step 502.

Next, at step 504, the mobile advertising platform would review the submitted advertising campaign and generate proposed requirements for the advertising campaign. As part of the review, the mobile advertising platform can be designed to generate a revenue model based on the indicated DMAs and duration of the campaign. Based on the generated revenue model, an estimate of the number of impressions required per DMA and the estimated hours of movement per DMA can then be determined.

Based on these requirements, a configuration of trailers that can meet the proposed requirements is then selected at step 506. In the present invention, the matching of trailers to the proposed advertising requirements is assisted by the previous profiling and categorization of trailers.

In one embodiment, the detailed requirements of the advertising campaign are presented to a fleet operator with a proposal for a use of a selected set of trailers that can optimally satisfy the requirements of the campaign. Here, the set of trailers proposed for the advertising campaign would match the designated DMAs and hours of movement within the DMAs. Additionally, based on the trailer categorizations, the estimated media or advertising revenue per trailer per DMA can also be provided to the fleet operator.

The fleet operator can then choose to opt-in to the proposed advertising campaign with the set of trailers that were proposed by the mobile advertising platform. Here, it is significant to note that the fleet operator need not be involved in the selection of the particular set of trailers for the advertising campaign. Rather, the primary considerations of the fleet operator could include whether or not the advertisement was objectionable, and whether or not the set of proposed trailers were going to be available during the duration of the advertising campaign. Should one or more of the proposed trailers be unavailable during the duration of the advertising campaign, a combination of one or more alternative trailers could be proposed based on the previously determined trailer categorizations.

In one embodiment, an advertising campaign need not be confined to the fulfillment of a single fleet operator. Rather, as the categorization of trailers for a plurality of fleet operators would be defined, the mobile advertising platform can propose an optimal selection of trailers across a plurality of fleet operators. In this process, the specific set of trailers chosen from a plurality of fleet operators would be chosen to match the particular needs of the advertiser with regard to the DMAs and the hours of movement within the DMAs.

As would be appreciated, the specific mechanism by which trailers are matched to an advertising campaign can vary based on the implementation. Trailers can be matched across various combinations of criteria based on revenue, duration, times of day, geography, etc. What is significant, however, is that the matching of trailers to advertising campaigns is assisted by the categorization of trailers that prevents an ad hoc selection of trailers for mobile advertising campaigns.

It is significant to note that the categorization of trailers also enables a fleet operator to maximize advertising revenue generated by opting-in with the best trailers that match the needs of the advertising campaign. With an ad hoc selection process, trailers that are not ideally matched to the needs of the advertising campaign would produce low metrics relative to the advertising targets. These low metrics would produce low relative advertising value for both the advertiser and the fleet operator. Consequently, a greater than needed number of trailers in a fleet may be deployed to an advertising campaign to produce the needed advertising targets. The opportunity costs of such mismatching are therefore significant to the fleet operator. This opt-in mechanism can also include a route and/or time recommendation for trailers traversing certain DMAs in order to improve impressions counts, targeting of certain zip codes, etc.

Returning to the flowchart of FIG. 5, the acceptance of the proposed use of trailers by the required set of fleet operators would trigger the launch of the advertising campaign. After the fleet operators have opted-in, the advertisement would then be installed on the selected trailers at step 508. In this process, mobile advertising platform 110 can also be designed to provide an interface (e.g., web-based) with advertisement installers. Through this interface, advertisement installers can provide mobile advertising platform 110 with information regarding location of installation sites, type of advertisement installs available, schedules, etc. After fleet operators have opted in to an advertising campaign, advertisement installers can then schedule the installation of the advertisement on the particular set of trailers that have been assigned to the advertising campaign. Next, at step 510, tracking devices would be installed on the selected trailers as required. Since it is time consuming and hence expensive in terms of time for trailers to be pulled off-line for installation, the installation of the tracking devices can be scheduled at the same time as the installation of the advertising wraps.

Once the advertisements have been installed by the advertisement installers and the trailers have been suitable equipped with tracking devices, the advertising campaign can then commence through the trailers normal activity in accordance with scheduled routing of the fleet operators. At step 512, the performance of the installed advertisements on the trailers would then be monitored. In this process, mobile advertising platform 110 would continually receive tracking updates from mobile tracking service provider 130 for each of the trailers assigned to the advertising campaign. This tracking information would then be combined with metrics provided by audience metrics service provider 140 to track the number of impressions (of many different types such as DEC, EOIs, demographics, etc.) for the assigned trailers. In addition to the total number of impressions, mobile advertising platform 110 can also track the average hours of movement of trailers per DMA, the average number of impressions and other audience characteristics per trailer per DMA, etc. Results of the performance monitoring can then be provided as proof-of-performance metrics to advertisers 150 and fleet operators 120.

In one embodiment, the movement of trailers can be tracked relative to a DMA or other geographically-defined region to ensure compliance with a defined advertising campaign. In one example, non-compliance that is determined through the crossing of a defined advertising boundary (e.g., geo-fencing) can lead to a removal of a particular trailer from a particular advertising campaign. As would be appreciated, the compliance determinations can be performed relative to any geographic region, route, time of day, or other dynamically tracked parameter that can be defined for an advertising campaign.

As has been described, the profiling and categorization of mobile advertisement carriers plays an essential role in the selection of mobile advertisement carriers to a particular advertising campaign. The creation of such a database of information enables many advertising applications.

In one example application, the mobile advertising platform 110 can identify the highest performing advertising assets from amongst the plurality of mobile advertisement carriers being tracked. Here, the notion of “highest performing” could be in relation to the number of impressions, demographics of audience, geographic areas, times of day, or any other metric that would be relevant to a targeted advertising campaign. These highest performing advertising assets can be designated as such and be provided with higher advertising rates relative to average performing mobile advertisement carriers.

In one embodiment, mobile advertising platform 110 can be configured to use route characterization to identify high-visibility routes within one or more DMAs. These high-visibility routes that identify high visibility areas, times, etc. can be provided to fleet operators as optional alternate routes that can increase the advertising performance of their mobile advertisement carriers. The fleet operators could then choose to alter their standard routes to opt for the alternate higher advertising revenue generating route. In general, the dynamic nature of the mobile advertisement platform enables identification of opportunities to adjust advertising operations to thereby increase the impressions and advertising efficacy.

In one embodiment, the provision of information regarding alternate, higher advertising performance routing can be generated for a fleet operator upon a request through the fleet operator's interface to the mobile advertising platform. For example, where the fleet operator has a mobile advertisement carrier that is designated to a given DMA, the fleet operator can request an alternate route that can generate higher number of impressions and hence advertising revenue. In another embodiment, the mobile advertising platform can be designed to monitor the profiles of the various mobile advertisement carriers to generate suggestions regarding changes in established patterns regarding routes used, times of routes used, etc. These suggestions can then be made available to the fleet operators for their consideration.

In one embodiment, the present invention also enables dynamic pricing models. Here, the mobile advertising platform can be configured to establish advertising pricing as a function of the DMAs and/or geographies covered, zip code and/or targeted demographic viewership, day of the week and/or time of the day, or the like. Using such dynamic pricing models, the mobile advertising platform can ensure that advertising directed to one or more desired targets are priced accordingly. This further ensures that advertising campaigns based on mobile advertisement carriers has a cost that is associated with actual impression performance that is monitored by the mobile advertising platform.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method for configuring a mobile advertising campaign, comprising the following computer implemented steps:
storing, in an electronic database, tracking information for a plurality of mobile advertising assets, said tracking information being derived from status information received from tracking devices associated with said plurality of mobile advertising assets, wherein said tracking information includes geographic position information;
determining an advertising profile for each of said plurality of mobile advertising assets, said advertising profile representing a relative value of a mobile advertising asset to an advertiser over a defined period of time, wherein said advertising profile is based on a number of impressions of an advertisement on a mobile advertising asset that is determined using said tracking information over said defined period of time;
configuring an advertising campaign based on said determined advertising profiles, said configuring including selection of one or more of said plurality of mobile advertising assets based on an analysis of said determined advertising profiles to requirements of said advertising campaign.

2. The method of claim 1, wherein said tracking information further includes operational status information that is chosen from a plurality of operational modes that includes moving and stopped.

3. The method of claim 1, wherein said determining comprises determining using information from an audience metrics service provider.

4. A method for configuring a mobile advertising campaign, comprising the following computer implemented steps:
receiving tracking information for a mobile advertising asset, said tracking information being derived from status information that is included in status reports that are received from said mobile advertising asset, wherein said tracking information includes information that enables identification of geographic positions;
identifying a number of impressions to an advertisement on said mobile advertising asset using said tracking information and audience metrics provided by an audience metrics service provider; and
determining an advertising profile for said mobile advertising asset, said advertising profile including, for a defined period of time, an identification of a number of impressions relative to geographic areas traversed by said mobile advertising asset during said defined period of time.

5. The method of claim 4, wherein said tracking information further includes operational status information that is chosen from a plurality of operational modes that includes moving and stopped.

6. The method of claim 4, wherein said audience metric is a daily effective circulation metric.

7. The method of claim 4, wherein said audience metric is an EYES ON metric.

8. The method of claim 4, wherein said advertising profile identifies hours of movement of said mobile advertising asset.

9. A mobile advertising system, comprising:
a mobile tracking service provider, said mobile tracking service provider generating geographic tracking information for a mobile advertisement carrier;
an audience metrics service provider that stores audience metrics information in relation to geographic positions; and
a mobile advertising platform that is configured to identify a number of advertising impressions for said mobile advertisement carrier based on said geographic tracking information received from said mobile tracking service provider and audience metrics information stored by said audience metrics service provider, wherein advertising costs administered by said mobile advertising platform is based on a time or location of said advertising impressions.

10. The system of claim 9, wherein said advertising cost is based on a segment of geography in which an impression occurred.

11. The system of claim 9, wherein said advertising cost is based on a zip code in which an impression occurred.

12. The system of claim 9, wherein said advertising cost is based on a day of week in which an impression occurred.

13. The system of claim 9, wherein said advertising cost is based on a time of day in which an impression occurred.

14. The system of claim 9, further comprising a fleet operator that registers said mobile advertisement carrier with said mobile advertising platform using a web-based interface.

15. The system of claim 9, further comprising an advertising entity that registers an advertising campaign with said mobile advertising platform using a web-based interface.
